(19) United States
(12) Patent Application Publication
(10) Pub. No.: US 2008/0222055 A1
(43) Pub. Date: Sep. 11, 2008

(54) System and Method for Creating Musical Works

(76) Inventor: John M. Hughes, Hebron, CT (US)

Correspondence Address: Goodwin Procter LLP, Patent Administrator, 53 State Street, Boston, MA, 02109-2881, US

(21) Appl. No.: 12/043,556

(22) Filed: Mar. 6, 2008

Related U.S. Application Data
(60) Provisional application No. 60/905,494, filed on Mar. 7, 2007.

(51) Int. Cl. G06Q 90/00

(52) U.S. Cl. 705/500

(57) ABSTRACT

In general, in one aspect, a method for creating a work, includes providing a first version of a work, and holding one or more contests for the development of one or more additions to the work. During the contests, contestants submit potential additions to the work, the submissions are evaluated, and one or more winning submissions selected. The winning submission is included in a new version of the work. The work may be distributed, and the proceeds of the distribution may be shared with the winner(s) of the one or more contests.

### RELATED APPLICATIONS

This application claims the benefit of and priority to U.S. Provisional Patent Application Ser. No. 60/905,494, filed on Mar. 7, 2007, entitled “System and Method for Creating Musical Works,” by John M. Hughes, attorney docket number TOP-014PR.

### TECHNICAL FIELD

The invention relates to computer-based methods and systems for creating musical works and, more particularly, to methods and systems for facilitating the distributed creation of musical works.

### BACKGROUND INFORMATION

The production of a musical work in a studio may involve the use of recording technology that allows a work to be recorded as different tracks, where each track is one, two, or more channels. While at one time each channel was one or more physical “tracks” on a recording media, with the advent of digital recording, each track may be played or recorded separately, communicated separately, and multiple tracks may be combined and/or played simultaneously. The use of digital tracks allows artists in a studio to collaborate on an audio work even without being in the studio at the same time. For example, a vocalist might record vocals on one track, and another vocalist might record other vocals on another track, while guitarists and percussion are recorded on still another track. A multi-track recording may be played with all tracks together, and ultimately may be combined into a final two or more channel format (e.g., stereo, surround-sound) for distribution.

Various music contests have been held, in which contestants submit songs for consideration by judges, and winning artists provided with prizes.

### SUMMARY OF THE INVENTION

A need exists, however, for technology to help artists collaborate in an efficient manner. It is often difficult for artists to find other artists to collaborate with them, or for beginning artists to collaborate with more experienced artists. Musicians, composers, and producers desire to quickly and efficiently develop works that will be received positively by an audience.

Embodiments of the invention may address these concerns by enabling competitions in which a number of artists submit candidate portions of a work for selection. Contests for creation of different portions of a work can result in a virtual collaboration, in which the various artists together create a final work, for example with each portion the best of those available. Once selected, for example, based on the quality of a contest submission, the creator who developed the selected portion of the work may collaborate with the other creator(s), engage in additional work in connection with the submission, or otherwise maintain a relationship with them.

In some embodiments, the collaboration is both artistic and economic, in that a prize for the acceptance of a submission includes a share in the proceeds from a final, finished, or completed work.

In general, in one aspect, a method for creating a work includes providing a first version of a work, such as a musical work, an audio/visual work, and so on. The method includes holding one or more contests for the development of one or more additional portions to the work. During the contests, contestants submit potential additional portions of the work, the submissions are evaluated, and one or more winning submissions may be selected. A winning submission may be included in a new version of the work. A combined work (e.g., including additional portions) may be distributed, and the proceeds of the distribution may be shared with the contest winner(s). The additional portions may be, for example, one or more instrumental tracks, vocal tracks, and so forth.

In general, in another aspect, a method for collaboratively creating content includes communicating to potential contributing artists a specification for contributions of one or more additional portions of a musical work. The method includes receiving submissions of one or more additions from one or more potential contributing artists in response to the specification, evaluating the submissions, selecting one of the submissions to be included in the work, and compensating the artist who submitted the submission to be added to the work.

In general, the work may be any suitable type of work. In one embodiment, the work is a musical work. The work may be a video work, or any other sort of work in which it is possible to allocate the creation of a portion of the work to development by another creator. For example, for a musical work, or work that includes audio, the addition to the work may be an additional audio track, which may be accompaniment, or otherwise. For example, the additional portion may be a track with one or more instruments. As another example, the additional portion may be musical or other sound accompaniment to a scene in a video. As other non-limiting examples, the additional portion may be an animated character's voice, an animation clip and/or overlay, or a graphical design, set, layout, titles, subtitles, directions, presentation slides, user interface element, and/or backdrop, and so on.

The contestants may be located in one geographic location or, more typically, in different locations and decentralized. The contest may be open to the public, or limited to a limited number of contestants. Contestants may be pre-qualified based on skill, previous performance, and so on.

The winner of a contest may be awarded a prize, which may be or may include a portion of the proceeds from licensing or distribution of the work. The steps may be repeated for additional contributions.

In some embodiments, a tool is provided to the potential contributors for adding to the musical work. The tool allows an addition to the made to the work, such that the addition is included in the combined work, but also may be played or displayed separately. For example, the tool may allow for the playing and recording of separate audio and/or visual tracks.

The methods described may be repeated for additional contributions to the work and/or modifications to the contributions.

In some embodiments, a first contest is held for contributions to a first version of a work, originally created by a first creator. The winning contest submission is selected by the first creator. The winning contest submission, provided by a second creator, is combined with the first version of the work to create a second version of the work. The original creator and the second creator may solicit submissions for an additional contribution to the second version of the work. The winning submission may be selected by the first creator and the second creator. The winning submission may be combined with the second version of the work to create a third version of the work. Thus, in these embodiments, a winning creator may become part of the collaboration in selecting further winners. Variations may allow more control to the original creator (for example by giving her increased control or sole control over the solicitation for submissions and/or selection of winning submissions). In some cases, a creator may be one or more people and/or there may be plural or singular contributors. In some cases, there may be a popular “vote” among a group of community members and/or web site visitors to determine, or to help determine the best submission.

In general, another aspect of the invention relates to a system for implementing the methods just described. The system includes a communications module for electronically distributing requirements for a submission to a distributed community of creators and receiving submissions from each of a subset of the community of creators in response to the submission requirements. The system includes a review module for facilitating evaluation of a subset of the received submissions by a number of reviewers; and a selection module for selecting a preferred submission in response to the facilitated review of the submissions.

In one embodiment of this aspect of the invention, the system further includes a rating engine for rating the skills of the members of the distributed community of musicians. The system may, in some embodiments, further include a reviewing module to allow members of the distributed community to review musical works.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram depicting creation of an exemplary work according to an embodiment of the invention.

FIG. 2 is a flow chart depicting steps performed in creating a work according to an embodiment of the invention.

FIG. 3 is a block diagram of an embodiment of a distributed system for facilitating creation of works having a server according to the invention.

FIG. 4 is a flow chart depicting an overview of the operation of an embodiment of the invention.

### DETAILED DESCRIPTION

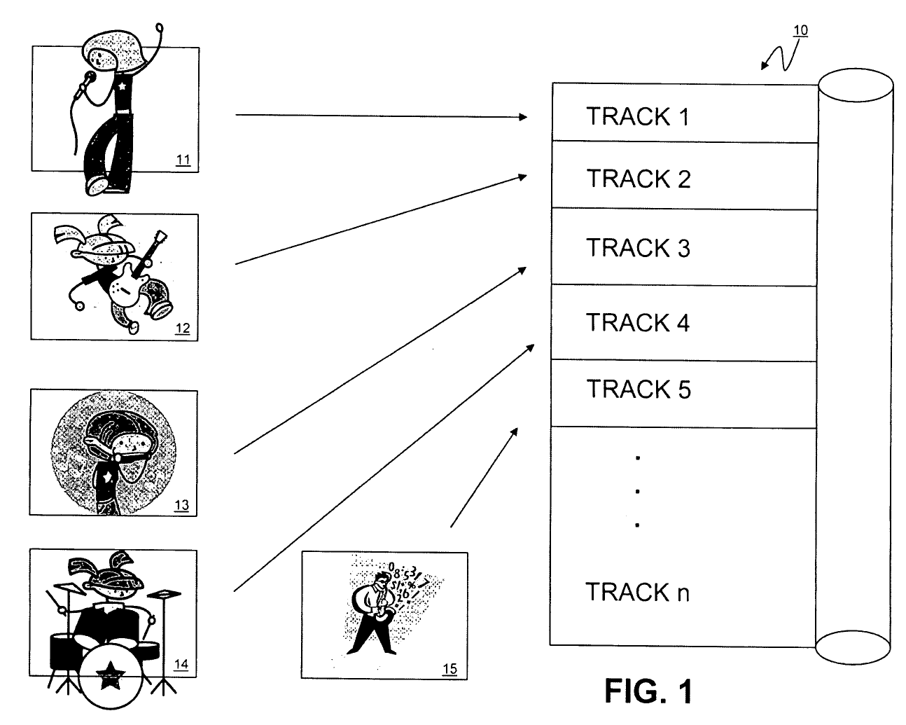

Referring to FIG. 1, an exemplary work 10, which in this case is a musical work, is made up of multiple portions, which in this case are tracks. A track may be one, two or more channels. The musical work 10 may be represented as a collection of tracks, shown by example as TRACK 1, TRACK 2, TRACK, 3, TRACK 4, TRACK 5, . . . TRACK n, and it should be understood that the number of tracks shown are exemplary, and there may be two, three, four, five, or any number of tracks. Each track may be allocated to one or more voices or instruments.

In this example, TRACK 1 is allocated to a vocalist 11, TRACK 2 is allocated to a guitarist 12, TRACK 3 is allocated to a harmonica player 13, TRACK 4 is allocated to a drummer 14, and TRACK 5 is allocated to a saxophone player 15. When the work 10 is played with all tracks simultaneously, the effect is such that all of the instruments are playing together, but each of the artists 11, 12, 13, 14, 15, may have been in the same or different room when the tracks were recorded. Each of the artists 11, 12, 13, 14, 15 may be listening to some or all of other already-recorded tracks when they are recording their tracks.

For example, it would be possible for the vocalist 11 to first record a song, at the same time as the guitarist 12. Later, the same or a different artist could listen to TRACK 1 (with the voice recording) and TRACK 2 (with the guitar) while playing a harmonica 13 that is recorded onto TRACK 3. Likewise, the drummer 14 and saxophone player 15 could listen to earlier tracks while recording their portions of the work. Thus, each artist could build on the contributions of the others, and provide a separate, yet beneficial addition to the work.

In some embodiments, an individual or business entity, such as an artist, producer, investor, and so one, conducts one or more contests for the creation of a work, in which each contest is for the creation of one or more portions of a work.

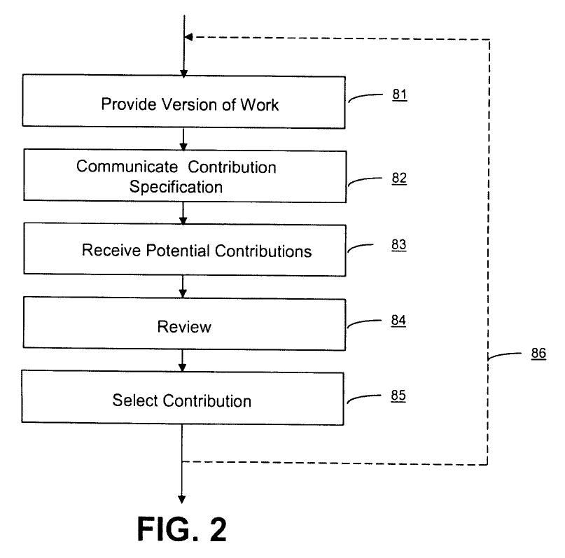

Referring to FIG. 2, in some embodiments, a first version of a work is made available (STEP 81). In the case where the work is a musical work, the first version may be, for example, one or more tracks of a song. Such a first version may include, for example, a voice track and/or a first instrument track (e.g., keyboard, percussion, guitar or other string instrument). There may be any number of tracks in the first version. The artist may make her work available using a system as further described herein, such that the first version of the work is published along with a solicitation for contributions to the work (STEP 82). In preferred embodiments, the specification is provided to a geographically distributed community of artists, who may be decentralized, and therefore some or all may located separately from each other. For example, the artists may be members of an organization, web site viewers, mailing list participants, and so on. There may be registration and/or prerequisites for viewing the solicitation and/or responding to the solicitation. The solicitation may include a specification for a desired contribution, including a description of characteristics of a desired contribution. The contribution specification may include technical requirements for the contribution, such as file formats, lengths, and so on. The contribution specification may include artistic requirements for the contribution, such as desired sound, instruments, effects, style and so on. The contribution specification may include deadlines and other information about contribution logistics. The contribution specification may include information about compensation or reward for accepted contributions.

In response to the specification, submissions of potential contributions are received (STEP 83). In preferred embodiments, each potential contributor has access to technology to facilitate review of the version of the work and the specification, and to contribute by generating a proposed contribution to the work.

The submissions are evaluated (STEP 84), and one or more winning submissions selected (STEP 85). Typically, the submissions would be evaluated by the person or people who initiated the contests. In some embodiments, submissions are screened, automatically, manually, or some combination, to determine compliance with the specification. Preferably, there are at least some stated criteria that the contribution must meet, but there may be a great deal of subjectivity, given the nature of differences in personal taste. In some embodiments, the creators of the work, which may include the creator of an original work and/or creators of any original and new additions, contributions, and/or versions of the work may evaluate the work. In some embodiments, a large number of people may evaluate the submissions, even if not actively participating. For example, the submissions may be available on a web site, and a vote taken (e.g., among all visitors, or a selected subset of the visitors) to select a group or community preference. The preference of the community may be advisory, and/or may be partially or fully determinative of the selection.

For example, in one embodiment, a loosely affiliated group of musicians each review the submissions and vote for their preference. In such case, the members of the group have incentives such that they stand to gain if the work ultimately becomes popular.

Winning submissions may be included in a new version of the work. Compensation may be made, and/or commitments for revenue sharing made.

These steps may be repeated (STEP 86), such that the new version of the work that includes the previous addition(s), may be made available once again with another specification for solicitation of additional potential contributions to the work, and contest(s) repeated for development of one or more further versions of the work.

When the work is completed, it may be distributed, and in some embodiments, proceeds from distribution may be shared with the winning contributors.

In some embodiments, a first contest is held for contributions to a first version of a work that is provided by a first creator. The winning contest submission is selected by the first creator. The winning contest submission, provided by a second creator, is combined with the first version of the work to create a second version of the work. The original creator and the second creator may solicit submissions for an additional contribution to the second version of the work. The winning submission may be evaluated and selected collaboratively by the first creator and the second creator. The winning submission may be combined with the second version of the work, thereby creating a third version of the work. Thus, in such embodiments, a winning creator can become part of the collaboration in selecting further winners, in addition to sharing in proceeds or other benefits that come from distribution of the work. Variations of these embodiments may allow more control to the original creator (for example by giving her greater control over the solicitation for submissions and/or selection of winning submissions). In some cases, there may be plural or singular contributors to the original or later versions of the work.

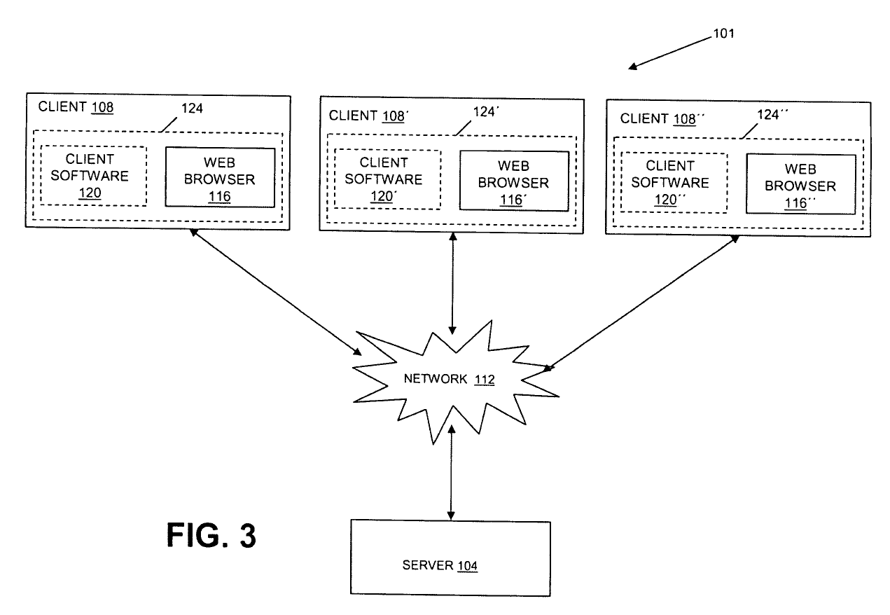

Referring to FIG. 3, in one embodiment, a distributed system for creating musical works 101 includes at least one server 104, and at least one client 108, 108′, 108″, generally 108. As shown, the system includes three clients 108, 108′, 108″, but this is only for exemplary purposes, and it is intended that there can be any number of clients 108. The client 108 is preferably implemented as software running on a personal computer (e.g., a PC with an INTEL processor, an APPLE MACINTOSH, etc.) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 could also be implemented on such hardware as a smart or dumb terminal, network computer, wireless device, wireless telephone, information appliance, mobile handheld device, workstation, minicomputer, mainframe computer, music player, or other computing device, that is operated as a general purpose computer, or a special purpose device.

Generally, in some embodiments, clients 108 can be operated and used by individuals to participate in various musical work creation activities. Examples of such activities include, but are not limited to participation the creation projects described here. Clients 108 can also be operated by entities who have requested that a work be created. The customers may, for example, use the clients 108 to review works developed using the system, post specifications for the development of works, view information about the community members, as well as other activities described here. The clients 108 may also be operated by a facilitator, acting as an intermediary between the customers and the creators.

In various embodiments, the client computer 108 includes a web browser 116, client software 120, or both. The web browser 116 allows the client 108 to request a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, in another embodiment, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered by the Mozilla Foundation.

In some embodiments, the client 108 also includes client software 120. The client software 120 provides functionality to the client 108 that allows an individual to participate, supervise, facilitate, or observe activities described here. The client software 120 may be implemented in various forms, for example, it may be in the form of a Java applet that is downloaded to the client 108 and runs in conjunction with the web browser 116, or the client software 120 may be in the form of a standalone application, implemented in a multi-platform language such as .Net or Java, or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface 124; for example, the client software can be implemented as a “plug-in” to the web browser 116.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on, and any combination. Preferably, the network 112 can carry TCP/IP protocol communications, and HTTP/HTTPS requests made by the web browser 116 and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired ethernet-based intranet, a local or wide-area network (LAN or WAN), and/or the global communications network known as the Internet, which may accommodate many different communications media and protocols.

The servers 104 interact with clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 104 may be or may be part of a logical group of one or more servers such as a server farm or server network. As another example, there may be multiple servers 104 that may be associated or connected with each other, or multiple servers could operate independently, but with shared data. In a further embodiment and as is typical in large-scale systems, the application software may be implemented in components, with different components running on different server computers, on the same server, or some combination.

In one embodiment, the server 104 and clients 108 enable the distributed creation of a work by one or more contributors, which contributors may or may not be associated with the individual or commercial entity requesting the creation of the work.

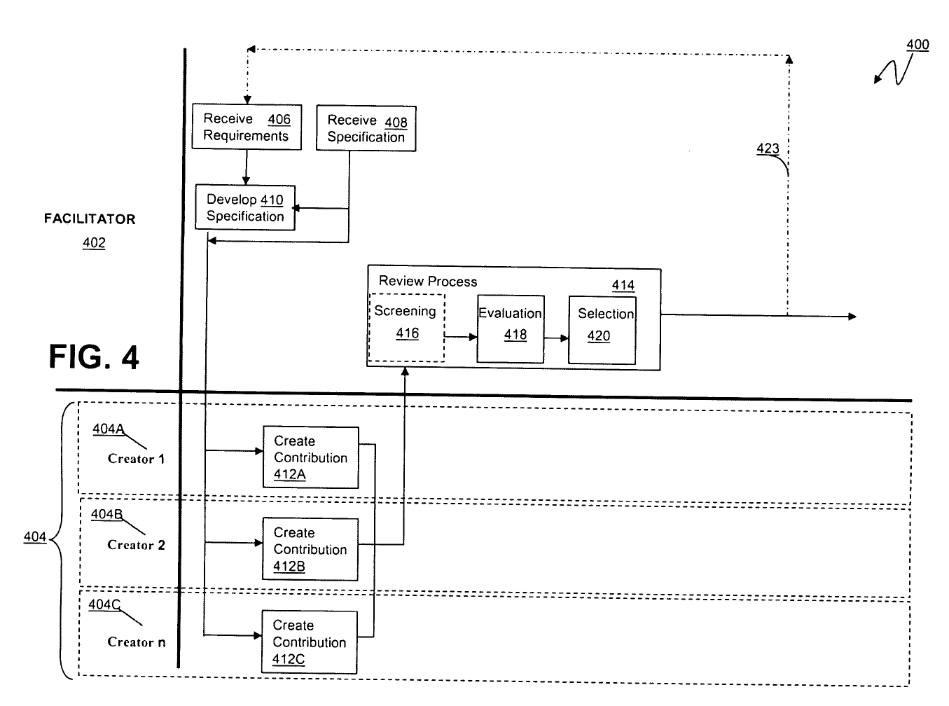

Referring to FIG. 4, a creative work development domain 400 may be used to provide an entity (e.g., individual and/or commercial entity) with a high-quality work. One or more creators can be identified and/or selected by various methods from a distributed community of creators, and subsequently used to create works. For example, the creators can be employees of, consultants to, or members of an organization, enterprise, or a community fostering collaborative and distributed creation of works. In some cases, the creators may have no other formal or informal relationship to each other. In some embodiments, the creators may include artists, designers, musicians, composers, illustrators, special effects engineers, as well as other creation roles.

In some embodiments, one or more of the creators can act as a project manager or facilitator 402 who is responsible for organizing and coordinating the efforts of other creators. The manager may also specify items such as, without limitation, the cost of the project, the project schedule, and the project risks. In one embodiment, the project manager creates a project plan for the project, which may include, without limitation, an estimated project cost and schedule, and a requirements specification document describing, for example, the parameters of the submission, and the scope and risks of the project.

In some embodiments, the creative process is monitored and managed by the facilitator 402. The facilitator 402 can be any individual, group, or entity capable of performing the functions described here. In some cases, the facilitator 400 can be selected from the distributed community of creators based on, for example, success with previously submitted portions of a work and/or achieving a high ranking. In other cases, the facilitator 402 can be appointed or supplied by the entity requesting the creation of the work, and thus oversee the creative process for further assurance that the end product will comport with the specifications.

Initially, the facilitator 402 receives input from an entity (not shown) wishing to have a work enhanced on their behalf. The entity can be, for example, a company looking to have one or more works created for a particular use in another work, or as a stand-alone work to be distributed and sold commercially. With respect to a musical work, the entity can be, for example, a producer or record label, an individual musician who would like to develop a song, a group of musicians, and/or a collaboration among such entities or others.

In some cases, the entity provides a detailed specification with the requirements for the work, and in other cases only a short list of requirements may be provided. The facilitator receives either the short list or description of requirements (STEP 406), a more complete specification (STEP 408), or in some cases both from an external entity. If, however, no specification is provided, or if the specification needs revisions to be useful, the facilitator can develop a specification in accordance with the requirements (STEP 410). For example, the requirements may describe only the desired addition(s) to the work in a general manner, while the specification may include the technical requirements for submission (e.g., file format, size, and the like). In some cases, one or more members 404 of the community may be asked to develop the specification, and in some cases multiple specifications may be submitted, with one of the submissions selected as the final specification to be used for guiding the creative effort.

In some cases, the specification is assigned a difficulty level, or some similar indication of how difficult the facilitator, entity, or other evaluator of the specification believes it will be to produce an addition to the work according to the specification. The difficulty level may, in some cases, also be based on the effort believed to be necessary to complete the task, and the time allotted to complete the task. The difficulty level may be expressed in any suitable manner, for example as a numerical measure (e.g., a scale of 1 to 10), a letter grade, or a descriptive such as easy, medium, or hard. For example, a specification for the creation of an addition to a work with many specific constraints may have a difficulty level of 9 on a scale of 1 to 10, whereas a simple addition without such constraints may be assigned a difficulty level of 2. If there are additional practical constraints, for example if the addition to the work is needed in a short amount of time (e.g., two days), the difficulty level optionally may be increased due to the tight time constraints. In some embodiments, an award to the creator (e.g., money, skill rating, allocation of royalties, etc.) that submits the selected addition may be produced or adjusted based in part on the difficulty level associated with the specification.

Once the specification is received (or developed), the facilitator 402 (or in some cases the entity, a project manager, review board member, or some combination of these and possibly others) reviews the specification to determine if it meets the requirements for a complete specification to be useful in this context.

Once complete, the specification is distributed to one or more potential creators 404, 404′, 404″ (generally, 404), who may be members, for example, of a distributed community of creators. In one non-limiting example, the creators 404 are decentralized and are not related to each other. For example, the creators may have no common employer, may be geographically dispersed throughout the world, and in some cases have not previously interacted with each other. However, as members of the community, the creators 404 may have participated in one or more previous competitions, and/or have had previously submitted additions to works. This approach allows an entity to gain access to a large pool of qualified potential creators.

The communication can occur over a communications network such as the network 112 (FIG. 3), such as via an email, instant message, text message, a posting on a web page accessible by the web browser 116 (FIG. 3), through a news group, facsimile, or any other suitable communication. In some embodiments, the communication of the specification can be accompanied by an indication of a prize, payment, commitment to future payments, or other recognition that is available to the creators (s) that submit selected additions to works. In some cases, the amount and/or type of payment may change over time, or as the number of participants increases or decreases, or both. In some cases multiple creators may be rewarded with different amounts, for example a larger reward for the first place submission, and a smaller reward for second place, etc. The number of creators receiving an award can be based on, for example, the number of creators participating in the project, the difficulty, or other attributes. In some cases, the reward is a predefined or later defined share of the proceeds from distribution of the work.

The recipients of the specification may be selected by various means. In some embodiments, members of the community may have expressed interest in participating in a project, whereas in some cases the individuals are selected based on previous performance in competitions, participation in prior projects, portfolio review, reviews by other members of the community, or other methods of measuring the skill and/or likelihood of success of a creator. For example, the members of the community of creators may be creators who have previously participated in a competition. In such a case, the skills of the participants may have been rated according to their performance, either individually, as a team, or in relation to others, and the ratings may be used to determine which creators are eligible to receive notification of a new specification or respond to a notification.

In one embodiment, the facilitator 400 moderates a collaborative forum among the various participants (the entity, the creators 404, etc.) to determine, discuss, or collaborate on desired features. The collaborative forum can consist of creators, customers, prospective customers, or others interested in the creation of certain works. In one embodiment, the collaboration forum is an online forum where participants can post ideas, questions, suggestions, or other information. In some embodiments, only a subset of the forum members can post suggestions to the forum.

Upon receipt of the specification, one or more creators 404 each develop additions to the work (STEPS 412A, 412B and 412C) in accordance with the specification. The development of the additions to the work can be done using any suitable system, for example, creative software provided the system, a development environment provided by the creator 404, or some combination thereof. Once a creator 404 is satisfied that her addition to the work meets the specified requirements, including the creative requirements, she submits her work, via the server, facsimile, email, mail, or another method.

It is possible, for example, to stop at various possible places in the process, for example, during the creation stage, and revise the specification with additional information (external information, or information generated by the process), generally in a manner that allows the participants 412 to be treated fairly. For example, if it comes to the attention of the facilitator that the specification was not clear, it may be possible to revise it appropriately, in a manner that does not unfairly prejudice the participants.

To determine which submission(s) will be selected, a review process 414 is used. This review can take place in any number of ways. In some cases the facilitator 202 is the reviewer. In some cases, the entity that requested the submissions is the only reviewer. In some cases, the facilitator 402 can delegate the review process to one or more members of the distributed community of creators, and/or to an appointee of the entity. The review process, in some embodiments, includes one or more creators 404 acting as a review group to review submissions.

In some embodiments, one or more reviewers screen 416 the submissions before they are reviewed by other reviewers. In some embodiments, the screening process includes determining whether the submissions meet the formal requirements outlined in the specification (e.g., format and elements submitted). In some embodiments, scores are documented using a scorecard, which can be a document, spreadsheet, online form, database, or other electronic document.

In one embodiment, one or more submissions that have passed initial screening 416, are then evaluated 418. Evaluation may be accomplished in any manner, including simply choosing based on personal preference, or by scoring the submissions based on predetermined criteria. In some embodiments, one or more reviewers score the submissions. In some embodiments, the scores are documented using a scorecard, which can be any form, including a document, spreadsheet, online form, database, or other electronic document. Scoring may be particularly useful in aggregating scores from multiple reviewers.

In some embodiments, the aggregation of input from multiple reviewers may include compiling information contained in one or more documents. In some embodiments, the facilitator 402 may resolve discrepancies or disagreements among reviewers. In various embodiments, aggregation may include a simple vote by a number of reviewers, which may be the general public, members of a community or group, members with a particular status or interest, and so on.

One or more winning submissions are selected 420 based on the submission. In one embodiment, one submission is selected as the winner. In one embodiment, the submission with the highest combined score is selected as the winning submission. In another embodiment, the submission that is the personal preference of one or more reviewers is selected as the winning submission. In another embodiment, the aggregated preferences of one or more reviewers is used as the winning submission.

A prize, payment and/or recognition is given to the winning creator. There can also be prizes, payments, and/or recognition for the other submissions. For example, the creators that submit the second and third best submissions may also receive payment, which in some cases may be less than that of the winning creator. Payments may also be made for creative use of technology, submitting a unique submission, or other such submissions.

In some embodiments, in addition to reviewing the submissions, a reviewer or facilitator may identify modifications to the submission that the reviewer would like included in the submission. The reviewer may select a winner, but subject to certain changes in the submission. The prize payment may be contingent upon those modifications to the submission. The reviewer may document the additional requirements, and communicate this information to the creator 412 who submitted the submission.

Once the reviewer validates that a final submission has sufficiently addressed the requirements of the specification, the reviewer may notify the facilitator 402 and/or external entity that such a submission has been accepted.

In one embodiment, once the screener identifies submissions that have met some or all of the requirements of the specification, the submissions are reviewed by a number of reviewers. There may be any number of reviewers. There may be one reviewer, two reviewers, or three reviewers. In one embodiment there are between 10 and 50 reviewers. In one embodiment, there are between 10 and 100 reviewers. In one embodiment there are between 10 and 1000 reviewers. In one embodiment, there are between 100 and 5000 reviewers. In another embodiment there are more than 5000 reviewers. The reviewers each review the submitted submissions and rate them, for example in the manner described above, but it may be a simple review, for example, just a rating of preference about which submission is better, with no other criteria requested. The review may be conducted as a public survey, in which input is received from a large number of people about which submission is better.

It should be understood that the review of the submissions can take place in any suitable way, depending on the number of reviewers and the number of submissions.

In some embodiments, there are multiple levels of review. For example, in some embodiments, one or more screeners determine whether submissions have met the formal requirements of the specification 416, for example, that a submission is complete and that the submission has met the required file formats and other requirements. A review board of a small number of reviewers (e.g., 1, 3, or 5) reviews the submissions 418 and evaluates the submissions. The reviewers may review the submission on objective and subjective criteria. The results of the review are evaluated, and a predetermined number of “best” submissions are selected 420, based on the results of the evaluation 418. Prizes or awards may be given to the creators whose submissions met this selection. In one embodiment, the “best” submissions are then provided to a larger group of reviewers. The larger group of reviewers can use the same criteria as the review board, or can provide a simpler like/dislike feedback, or a preference rank. Each of the submissions presented to the larger group are the ones that have most closely met the criteria and the subjective preference of the reviewers, so the larger group can be used to determine the submissions that have a more general appeal.

It should be understood that there may be any number of participants in the various levels of review. Thus, in one embodiment, a larger group is used as a first stage of review, to reduce the set of submissions to a small number of candidates, and then the smaller number of candidates are reviewed by a smaller group. In another embodiment, a smaller group is used as a first stage of review, to reduce the set of submissions to a small number of candidates, and then the smaller number of candidates are reviewed by a larger group. Likewise, there may be multiple levels of review (not shown), in which larger or smaller groups participate in the review. In one such embodiment, increasingly larger groups of reviewers (e.g., three, four, or more groups of reviewers) are consulted as the number of candidates is reduced. In another embodiment, increasingly smaller groups of reviewers (e.g., three, four, or more groups of reviewers) are consulted as the number of candidates is reduced.

In one exemplary embodiment, after screening, there are 25 submissions that meet the criteria of the requirements. The facilitator 402 decides that because of the nature of the project, it would be best to provide reviewers with ten candidates from which to choose. The facilitator 402 and/or one or more reviewers select the ten submissions that the reviewers believe to be the best candidates for review by a larger group. In another context, the reviewers might present all 25 to the larger group of reviewers. There may even be situations where many more candidates are presented to the larger group. In general, however, a goal is to provide the review group with a smaller number of choices, so as to reduce the time and effort needed by each member of the larger group of reviewers.

The number of submissions selected can be any number that is suitable for selection by a larger group. Depending on the number of reviewers in the larger group of reviewers, there are different techniques that can be used to select the candidates. In one embodiment, the system facilitates the review by the reviewers by presenting the choices to the reviewers, with a mechanism to provide feedback. The feedback can be a simple indication of the preference of each (e.g., yes/no, or number evaluation) or a ranking (e.g., assigning an order of preference) to each. Any suitable technique can be used to solicit and aggregate response indicia from the reviewers. In one embodiment, each reviewer gets one or more “veto” votes to eliminate a candidate that the reviewer does not like.

Once the candidate set is identified, a larger group of reviewers may be used to select one or more “best” submissions. The larger group of reviewers may be the intended audience for the submission. The larger group of reviewers may include other creators, members of the requesting entity (e.g., employees of the company such as sales and marketing personnel), or any other suitable group or combination of groups of people. In one embodiment, the reviewers include people who are not affiliated with the entity, but who have agreed provide their opinion about the submission. The demographics (e.g., where they live, what language(s) do they speak, their ages, incomes, etc.) of the larger group of reviewers may be important considerations in selecting the larger group.

The larger group of reviewers may be compensated in some way for their participation. For example, the reviewers may be provided with monetary or other rewards or prizes and/or an opportunity to participate in a contest, drawing, lottery or so forth for one or more rewards. Participation in one or more larger groups of reviewers may be a requirement for submitting a submission. For example, in one embodiment, creator needs to participate in a predetermined number of larger group reviews during a predetermined time period (e.g., week, month, calendar quarter) to have an ability to submit a submissions.

The larger group reviewers may be ranked and/or rated, for example based on how reliable they are, how quickly they respond, and/or how well their selections comport with the selection of the larger group(s) in the review(s) that they participate in.

In one embodiment, the larger group of reviewers are invited by email to review the submissions. Each of the larger group of reviewers receives an email message directing them to a web page that includes the list of candidate submissions. In one embodiment, it is possible to listen (and/or view) the submission itself separate from the original work, and also to listen (and/or view) the submission as combined with the work.

In one embodiment, the original work is provided with each of the submissions in one of the tracks, to facilitate comparison of the submissions as the work is played.

In one embodiment, the candidates are identified on a page, with any additional information needed for review, as well as a selection tool for assigning response indicia. For example, if there are ten candidate submissions, each submission may be assigned a response indicia from 1 to 10, and the reviewer is asked to assign a number to each submission in order of the reviewer's preference for the submission. In another example, the reviewers are asked to evaluate specific characteristics of the submission (e.g., sound, appeal, thematic representation, etc.) and/or give an overall evaluation or preference. The specific characteristics may be evaluated individually, or by assigning a number to each in order of preference. In another example, a free-form text entry field may be provided where the reviewers can describe the specific characteristics of each submission.

While any suitable interface can be used, presenting the submissions in a manner that allows each candidate submission to be compared to each other, facilitates efficient review by each reviewer. It also allows for effective aggregation as described below. If the submissions can not easily be compared on the same page, there can be an indicator for the submission on a review page, for example with a summary image for the submission, and links to the full presentations of the candidate submissions. Any suitable system for providing a response indicia can be used, depending on the method used for aggregating the results. Generally, a web page is used to collect the reviewers feedback on the submissions. Any suitable technique may be used, including without limitation selection by telephone, mobile telephone, and so on.

Results from the reviewers can be aggregated, for example, by any suitable method, to identify the most preferred submissions. For example, in one embodiment, the Schulze method is used for the comparison. The Schulze method has the advantage that if there is a candidate that is preferred pairwise over the other candidates, when compared in turn with each of the others, the Schulze method guarantees that that candidate will win. Other methods that are Condorcet methods (i.e., promote the pairwise winner) are also may be suitable, as may be any other suitable voting system, such as Borda and Instant-runoff voting.

In some embodiments, it is useful to select a number of candidates in their order of preference, and also to communicate how close the response was from the larger group of reviewers with regard to the top selections. For example, the requesting entity may not prefer the top choice selected by the reviewers, but might prefer to select on its own from the top choices determined by the larger group.

In some embodiments, the selected submission(s) are used as input 423 for another round of creation. The submission(s) are included along with the requirements 406 and specification 410 are developed, as guidance for the further development of submissions. For example, if an initial repetition of the method results in the selection of three submissions, those three submissions can be included with the specification, with an indication of the aspects of those features that are desired. In the revised specification, creators may be asked to include aspects of those features in their submissions in a following round.

In iterative embodiments, there can be any number of rounds in which output from one round is used as part of the input for the next round. Through such an iterative process, e.g., by taking the output 423 and using that as input for another round, it is possible for the entity that is requesting submissions to come incrementally closer to a desired submission, with a process that allows freedom and creativity for the creators within the guidelines of the specification.

In another embodiment, the selected submission(s) are incorporated in the work, and the combined work used as input 423 for solicitation of further creation. Additional requirements 406 and specification 410 may be developed for more additions to the work. For example, using the example of FIG. 1, it may be that the original work included a voice track (TRACK 1) created by a vocalist 11 and guitar track (TRACK 2) created by a guitarist 12, and the first requirements and specification were for a percussion track (TRACK 4). After the creation 412 of percussion track, optional screening 416, and evaluation 418, a percussion track is selected 420, and the percussion track is added to the work. The combined work 423 may be then be used with a revised specification with requirements for a harmonica track (TRACK 3). After the creation of harmonica contributions 412, optional screening 416, evaluation 418, and selection 420, the selected harmonica track may be added to the work, and the combined work 423 provided again with a request for a saxophone track, and so on. Thus the process may be conducted iteratively to create a work by combining different portions.

In one embodiment, creators that submit submissions are rated based on the results of their submissions. The ratings are calculated based on the ratings of each creator prior to the submission, and possibly such other factors as an assigned difficulty level of the submission, and the number of other creators making submissions, and the feedback received for the submission. If the difficulty is used in the rating, an assessment of the difficulty of the project will be made when it is accepted. Generally, the amount paid for a project may bear a relationship to the difficulty of the project, and so in some embodiments, it may be possible to use one to determine the other. A skill rating is calculated for each creator based on each creator's rating prior to the submission and a constant standard rating (e.g., 1200), and a deviation is calculated for each developer based on their volatility and the standard rating.

The expected performance of each creator submitting a submission is calculated by estimating the expected score of that creator's submission against the submissions of the other creators' submissions, and ranking the expected performances of each creator. The submission can be scored by a reviewer using any number of methods, including, without limitation, those described above. The submission can be scored based on one or more metrics, or on the result of whether the submission candidate is ultimately selected. Thus, an expected score may be a score, or a reflection of the expectation that the submission will be one of the best submission(s) selected.

Based on the score of the submitted software and the scores of submissions from other creators (e.g., whether for the same submission or one or more other programs having a similar level of difficulty), each creator is ranked, and an actual performance metric is calculated based on their rank for the current submission and the rankings of the other creators. In some cases, the submissions from other creators used for comparison are for the same submission. In some cases, the submissions from other creators are submissions that are of similar difficulty or scope.

A competition factor also can be calculated from the number of creators, each creator's rating prior to the submission of the submission, the average rating of the creators prior the submissions, and the volatility of each creator's rating prior to submission.

Each creator can then have their performance rated, using their old rating, the competition factor, and the difference between their actual score and an expected score. This performance rating can be weighted based on the number of previous submissions received from the creator, and can be used to calculate a creator's new rating and volatility. In some cases, the impact of a creator's performance on one submission may be capped such that any one submission does not have an overly significant effect on a creator's rating. In some cases, a creator's score may be capped at a maximum, so that there is a maximum possible rating. The expected project performance of each creator is calculated by estimating the expected performance of that creator against other creators and ranking the expected performances of each participant. The submissions and participants can be scored by the facilitator 400, the entity 208, a review board member, and/or automatically using the software residing, for example, on the server 104 using any number of methods.

One such example of scoring methodology is described in U.S. Pat. No. 6,569,012, entitled “Systems and Methods for Coding Competitions” by Lydon et al, at, for example, column 15 line 39 through column 16 line 52, and column 18 line 65 through column 21 line 51, and incorporated by reference in their entirety herein. The methodology is described there with reference to programming competitions, and is applicable to rating the development of submissions, as well as data models, applications, components, and other work products created as a result of using the methodology described above.

Although described here with reference to musical works, and useful when implemented with regard to musical works, the cooperatively developed work may be any sort of artistic work, such as a video or movie, an architectural work, books, other audio works, and so on. The works may be copyrightable works, or otherwise. In general, the additions to the work are portions of one work. It is also possible to use the techniques described to create collections of works. The techniques described can be particularly effective when there are multiple tracks of the work, that may be overlaid or combined to form a final or more complete work.

What is claimed is:

1. A method for creating a work, comprising:
providing a first version of a work;
holding one or more contests for the development of one or more respective additional portions of the work, in which the contestants in each contest submit potential additions to the work, submissions are evaluated, and one or more winning submissions selected;
including each of the winning submissions in a new version of the work; and
distributing the work.

2. The method of claim 1, wherein the addition to the work comprises an additional track.

3. The method of claim 1, wherein at least one addition to the work comprises musical accompaniment.

4. The method of claim 1, wherein the contestants are decentralized.

5. The method of claim 1, wherein the contest is public.

6. The method of claim 1, wherein the contest is limited to a limited number of contestants.

7. The method of claim 1, wherein the winner of the contest is awarded a prize.

8. The method of claim 7, wherein the prize is a portion of the proceeds.

9. The method of claim 1, comprising repeating the steps for additional contributions.

10. The method of claim 1, further comprising sharing the proceeds from the distribution with the winners of the one or more contests.

11. A method for collaboratively creating content, comprising:
communicating to potential contributing artists a specification for contributions of one or more additions to a musical work;
receiving submissions of one or more additions from one or more potential contributing artists in response to the specification, wherein the additions each comprise a musical track that may be combined with the musical work to form a new musical work;
evaluating the submissions;
selecting one of the submissions to be added to the work;
compensating the artist who submitted the submission to be added to the work.

12. The method of claim 11, further comprising providing a tool to the potential contributing artists for adding to the musical work.

13. The method of claim 12, further comprising, repeating the method for additional contributions to the work.

14. A method for creating an audiovisual work, comprising:
providing a first version of the audiovisual work;
holding one or more contests for the development of one or more respective additional portions of the work, in which the contestants in each contest submit potential additions to the work, submissions are evaluated, and one or more winning submissions selected;
including each of the winning submissions in a new version of the work; and
distributing the work.
